(19) United States
(12) Patent Application Publication
(10) Pub. No.: US 2008/0137537 A1
(43) Pub. Date: Jun. 12, 2008

(54) Method for optimal packet scheduling for wireless and mobile communications networks

(76) Inventors: Bader Al-Manthari, Kingston (CA); Hossam Hassanein, Kingston (CA); Nidal Nasser, Etobicoke (CA)

Correspondence Address: Stephen J. Scribner;PARTEQ Innovations, Room 1625, Biosciences Complex, Queen's University, Kingston, K7L 3N6, omitted

(21) Appl. No.: 11/984,841

(22) Filed: Nov. 21, 2007

Related U.S. Application Data
(60) Provisional application No. 60/860,487, filed on Nov. 22, 2006.

(51) Int. Cl. H04L 12/28

(52) U.S. Cl. 370/238

(57) ABSTRACT

This invention relates to a centralized packet scheduler for a wireless communications network such as HSDPA, 1×EV-DO Revisions 0, A and B, WiMAX, infrastructure-mode WiFi and any other type of network where centralized packet scheduling is applicable. The invention provides a utility-opportunity cost packet scheduling scheme for high-speed access that simultaneously achieves efficiency, fairness, user satisfaction, and flexibility. The scheme employs a flexible utility function that incorporates the channel quality conditions of the users as well as a fairness measure. The utility function maximizes user satisfaction as perceived by the service provider while ensuring that users with favourable instantaneous channel quality conditions do not monopolize the radio resources. In addition, the scheme uses an opportunity cost function to allow the service provider to optimize fairness in the context of network throughput and hence, to control the system capacity. The scheme combines the requirements of users (e.g., throughput, delay, fairness, etc.) with the requirements of the service provider (e.g., revenue) in making scheduling decisions.

### RELATED APPLICATIONS

This application claims the benefit of the filing date of U.S. Provisional Patent Application Ser. No. 60/860,487, filed on 22 Nov. 2006, the contents of which are incorporated herein by reference in their entirety.

### FIELD OF THE INVENTION

This invention relates to methods for controlling and optimizing packet scheduling in wireless communications networks so as to maximize revenue of the service provider by controlling the cost of scheduling transmission packets while satisfying the Quality of Service (QoS) of users and maintaining a level of fairness to all users.

### BACKGROUND OF THE INVENTION

The increasing demand for high-speed mobile data applications has led to the development of new wireless cellular systems that can support high data rates that are beyond the capabilities of the traditional 2.5G and 3G wireless cellular networks. For example, the 3rd Generation Partnership Project (3GPP) has standardized a 3.5G system called High Speed Downlink Packet Access (HSDPA) [1] as an extension to the existing 3G Universal Mobile Telecommunications System (UMTS). HSDPA can theoretically support up to 14.4 Mbps, 7 times larger than the data rate offered by UMTS. Another example is the 1× EVolution Data Optimized Revision A (1×EV-DO Rev A) which is an HSDPA-like system standardized by the 3rd Generation Partnership Project 2 (3GPP2) [2]. 1×EV-DO Rev A can achieve peak downlink data rates of up to 3.1 Mbps. The high data rates offered by these systems allow them to deliver a competitive advantage for mobile data service providers by boosting network performance to improve the user experience of new, converged services such as streaming video, mobile Internet browsing and Voice over IP (VoIP).

However, to maximize the capacity and accommodate as many users as possible while maintaining the quality of service (QoS) of their ongoing connections, these systems require effective radio resource management schemes. A key component of any radio resource management scheme is packet scheduling. Packet scheduling plays an important role in wireless cellular networks since these networks are characterized by high speed downlink shared channels to support the increasing number of mobile data users. A centralized downlink packet scheduler is implemented at the base station of the network to control the allocation of the downlink shared channels to the mobile users by deciding which users should transmit during a given time interval and thus, to a large extent, the scheduler determines the overall behaviour of the network. Therefore, packet schedulers are typically designed to maximize the efficiency of the wireless cellular network and hence, maximize the obtained revenues of the service provider.

### SUMMARY OF THE INVENTION

One aspect of the invention relates to a method for maximizing revenue of a wireless communications network provider, the network including a plurality of users, comprising: determining packet scheduling for downlink transmission for each user according to a utility function and an opportunity cost function; and scheduling transmission for each said user; wherein the utility function considers the satisfactions and preferences of the users and the opportunity cost function considers the revenue preference of the service provider; and wherein a result of the utility function and the opportunity cost function determines network fairness.

In one embodiment scheduling transmission may comprise selecting for transmission a user that maximizes the utility function for the network and provides fairness to the users. The network utility may be the sum of users' utilities, wherein users' utilities are based on one or more performance metrics and on the distribution of the performance metrics among users. The performance metric may include at least one of channel quality, throughput, delay, delay jitter, and packet loss. In one embodiment, the utility function may be based on the Cobb-Douglas utility function.

In another embodiment scheduling transmission may comprise selecting for transmission a user that satisfies an opportunity cost function and provides fairness to the users. In a further embodiment, scheduling transmission may comprise selecting for transmission a user that maximizes the utility function for the network subject to the opportunity cost function, and provides fairness to the users.

Fairness may be determined by comparing a user's average throughput to the maximum average throughput of all users. Network fairness to users may be associated with an opportunity cost to the service provider. The opportunity cost of scheduling transmission for a user may increase as the channel quality condition of the user deteriorates. Fairness may increase faster when a user with a low average throughput is selected for packet scheduling rather than a user with a high average throughput.

In one embodiment service provider revenue is maximized by bounding the opportunity cost of scheduling transmission for a user and allowing the bound to control trade-off between network throughput and network fairness. This may be performed at each time transmission interval which is the time between two consecutive transmissions.

The method may be performed in a wireless network where centralized downlink packet scheduling is applicable. The wireless network may be selected from HSDPA, 1×EV-DO Revision 0, 1×EV-DO Revision A, 1×EV-DO Revision B, WiMAX, infrastructure-mode WiFi networks (where in infrastructure-mode WiFi networks, stations are connected to the network through a WiFi Access Point), or any other wireless network where packet scheduling is required.

Another aspect of the invention relates to a method for maximizing revenue of a wireless communications network provider, the network including a plurality of users, comprising: determining packet scheduling for downlink transmission for each user according to a utility function and an opportunity cost function; and scheduling transmission for each said user; wherein the utility function considers the satisfactions and quality of service (QoS) preferences of the users and the opportunity cost function considers the revenue preference of the service provider (also referred to herein as “network provider” or “network operator”); and wherein a result of the utility function and the opportunity cost function determines network fairness.

In one embodiment scheduling transmission may comprise selecting for transmission a user that maximizes the utility function for the network and provides fairness to the users. The network utility may be the sum of users' utilities, wherein users' utilities are based on one or more QoS performance metrics and on the distribution of the performance metrics among users. The QoS performance metric may include at least one of channel quality, throughput, delay, delay jitter, and packet loss. In one embodiment, the utility function may be based on the Cobb-Douglas utility function.

In another embodiment scheduling transmission may comprise selecting for transmission one or more users that satisfy an opportunity cost function and provide fairness to the users. In a further embodiment, scheduling transmission may comprise selecting for transmission one or more users that maximize the utility function for the network subject to the opportunity cost function, and provide fairness to the users.

Fairness may be determined by comparing a user's average throughput to the maximum average throughput of all users for the case of best-effort traffic. For cases of traffic with specific data rate or packet delay requirements, fairness may be determined by comparing a user's average data rate or average packet delay to his requested ones. Network fairness to users may be associated with an opportunity cost to the network operator. The opportunity cost of scheduling transmission for one or more users may increase as their channel quality conditions deteriorate. Fairness may increase faster when one or more users with low average throughputs (or high packet delays) are selected for packet scheduling rather than those users with high average throughputs (or low packet delay).

In one embodiment, network operator revenue is maximized by bounding the opportunity cost of scheduling transmission for one or more users and allowing the bound to control trade-off between network throughput and network fairness. The method may be performed at each time transmission interval which is the time between two consecutive transmissions.

In one embodiment, users may have the same QoS requirements. The QoS requirements may be related to a traffic type selected from best-effort traffic, traffic with data rate requirements, and traffic with delay requirements. The QoS requirements may include one or more performance metric selected from channel quality, throughput, packet delay, delay jitter, and packet loss.

In another embodiment, users may have different QoS requirements. The QoS requirements may be related to two or more traffic types selected from best-effort traffic, traffic with data rate requirements, and traffic with delay requirements. The QoS requirements may include one or more performance metric selected from channel quality, throughput, packet delay, delay jitter, and packet loss.

The method may be performed in a wireless network where centralized downlink packet scheduling is applicable. The wireless network may be selected from HSDPA, I×EV-DO Revision 0, I×EV-DO Revision A, I×EV-DO Revision B, WiMAX or infrastructure-mode WiFi networks (where in infrastructure-mode WiFi networks, stations are connected to the network through a WiFi Access Point) or any other wireless network where centralized packet scheduling is required.

Another aspect of the invention relates to a packet scheduler adapted to implement the method described herein.

Another aspect of the invention relates to a wireless communications network comprising at least one packet scheduler as described above. In one embodiment, the packet scheduler is provided in a Medium Access Control (MAC) layer of the network.

### BRIEF DESCRIPTION OF THE DRAWINGS

The invention will now be described, by way of example, with reference to the accompanying drawings, wherein:

FIG. 1 is a diagram of a packet scheduler model for wireless networks according to an embodiment of the invention;

FIG. 2 is an algorithm showing major steps in an embodiment of the Utility-Opportunity Cost Packet Scheduler (UOC-PS) of the invention;

FIG. 3 is a plot of the fairness measure Xᵢ₂(t) as a function of a user's relative fairness a, according to the algorithm of FIG. 2;

FIG. 4 shows the network architecture of a typical Universal Mobile Telecommunications System (UMTS);

FIG. 5 is a diagram of the simulation model used to verify the performance of the UOC-PS of the invention;

FIG. 6 is a plot comparing the cell throughput of the UOC-PS scheme at two values of K with the Max CIR scheme and the Proportional Fairness (PF) scheme;

FIG. 7 is a plot showing the cell throughput of the UOC-PS scheme at various values of K;

FIG. 8 is a plot comparing the Cumulative Distribution Function (CDF) of the users' average throughputs of the UOC-PS scheme at two values of K with the Max CIR and the PF schemes;

FIG. 9 is a plot showing the Cumulative Distribution Function (CDF) of the users' average throughputs of the UOC-PS scheme at various values of K;

FIG. 10 is a plot of percentage of satisfied users as a function of number of users for the UOC-PS (K=7.3 Mbps) scheme and the Max CIR and the PF schemes, with a minimum throughput guarantee of 128 Kbps;

FIG. 11 is a plot of percentage of satisfied users as a function of number of users for the UOC-PS scheme at various values of K, with a minimum throughput guarantee of 128 Kbps;

FIG. 12 is a plot of percentage of satisfied users as a function of number of users for the UOC-PS (K=7.3 Mbps) scheme and the Max CIR and the PF schemes, with a minimum throughput guarantee of 356 Kbps

FIG. 13 is a plot of percentage of satisfied users as a function of number of users for the UOC-PS scheme at various values of K, with a minimum throughput guarantee of 356 Kbps;

FIG. 14 is a plot of average user throughput as a function of Signal-to-Noise Ratio (SNR) for the UOC-PS (K=7.3 Mbps) scheme and the Max CIR and the PF schemes; and

FIG. 15 is a plot of percentage of average packet loss as a function of SNR for the UOC-PS (K=7.3 Mbps) scheme and the Max CIR and the PF schemes.

### DETAILED DESCRIPTION OF PREFERRED EMBODIMENTS

One factor that should be considered in the design of a packet scheduler is the wireless users' channel quality conditions. In particular, wireless mobile users experience varying channel conditions that affect their supportable data rates from the base station. The data rate is affected by their mobility, interference caused by other users in the system, obstacles that block or divert their transmitted or received signals, etc. Often, the packet scheduler tracks the instantaneous channel conditions of the users and selects for transmission users who are experiencing good channel conditions in order to maximize the network capacity. However, serving users based on their favourable channel quality conditions raises the issue of fairness, as those users with poor channel conditions may not get served. Therefore, a good packet scheduler should efficiently incorporate fairness and capacity in its scheduling decisions, and balance the trade-off between them.

Another factor that should be considered in the design of a packet scheduler is the QoS requirements of the different users. Since future wireless cellular systems will support a wide range of multimedia applications that have different QoS requirements. Such requirements should be taken into consideration while scheduling users for transmission to satisfy their requirements.

Several packet scheduling schemes have been proposed for wireless cellular networks, such as the Maximum Carrier-to-Interference Ratio (Max CIR) scheme [3], the Proportional Fairness (PF) scheme [4] and the channel quality indicator scheme [5]. However, they are all based on a priori knowledge of the radio channel condition of each user. Also, all the available radio resources are assigned to the user with the optimal or near optimal radio channel conditions and, therefore, these algorithms suffer from the fairness problem.

According to a broad aspect, this invention relates to a centralized packet scheduler for a wireless communications network such as HSDPA, 1×EV-DO Revisions 0, A and B, WiMAX and infrastructure-mode WiFi networks and any other type of network where centralized packet scheduling is applicable. The invention provides a utility-opportunity cost packet scheduling scheme for high speed access that simultaneously achieves efficiency, fairness, user satisfaction, and flexibility. This scheme, referred to herein as the Utility-Opportunity Cost Packet Scheduler (UOC-PS), employs a flexible utility function that competently incorporates the channel quality conditions of the users as well as a unique fairness measure. The utility function is designed to maximize user satisfaction as perceived by the service provider (also referred to herein as “network provider” or “network operator”) while ensuring that users with favourable instantaneous channel quality conditions do not monopolize the radio, resources. In addition, UOC-PS utilizes an opportunity cost function to allow the service provider to optimize fairness in the context of network throughput, and hence, to control the system capacity, which is a unique feature that distinguishes the UOC-PS from other existing schemes. The UOC-PS combines the requirements of users (e.g., throughput, delay, fairness, etc.) with the requirements of the service provider (e.g., revenue) in making scheduling decisions. Moreover, to ensure downward compatibility with existing schemes, the UOC-PS can function as a Maximum Carrier-to-Interference-Ratio (Max CIR) scheme or a Proportional Fairness (PF) scheme if the network conditions warrant. The method maybe applied to downlink packet scheduling at the base station of a wireless communications network.

As used herein, the term “efficiency” refers to the way in which variation in channel quality conditions of users is exploited so that users can send data at higher data rates. For example, efficiency may be achieved when more users with good channel conditions are selected for transmission.

As used herein, the term “fairness” refers to the way in which one or more performance metrics (e.g., throughput, delay, data rate) of users is distributed. For example, fairness may be achieved when users with poor channel conditions are given more channel time slots to compensate for their low average throughput.

As used herein, the term “user satisfaction” refers to one or more parameters of system performance (also referred to as QoS (quality of service) performance metrics), such as average throughput, data rate, average delay, etc., attaining or exceeding a predefined value for the user.

As used herein, the term “flexibility” refers to the freedom experienced by the service provider to control network parameters, including the degree of fairness of the scheduler, and hence the system throughput.

As used herein, the term “utility” refers to a mathematical function relating to user satisfaction of received service and it includes QoS metrics and fairness measurements representing how fair the scheduling algorithm is to the user. Network utility is the sum of users' utilities, which are based on performance metrics and on the distribution of the performance metrics among users. The utility of each user may include any QoS metric, such as, but not limited to channel quality, throughput, delay, delay jitter, and packet loss.

As used herein, the term “wireless user” is intended to include a mobile user.

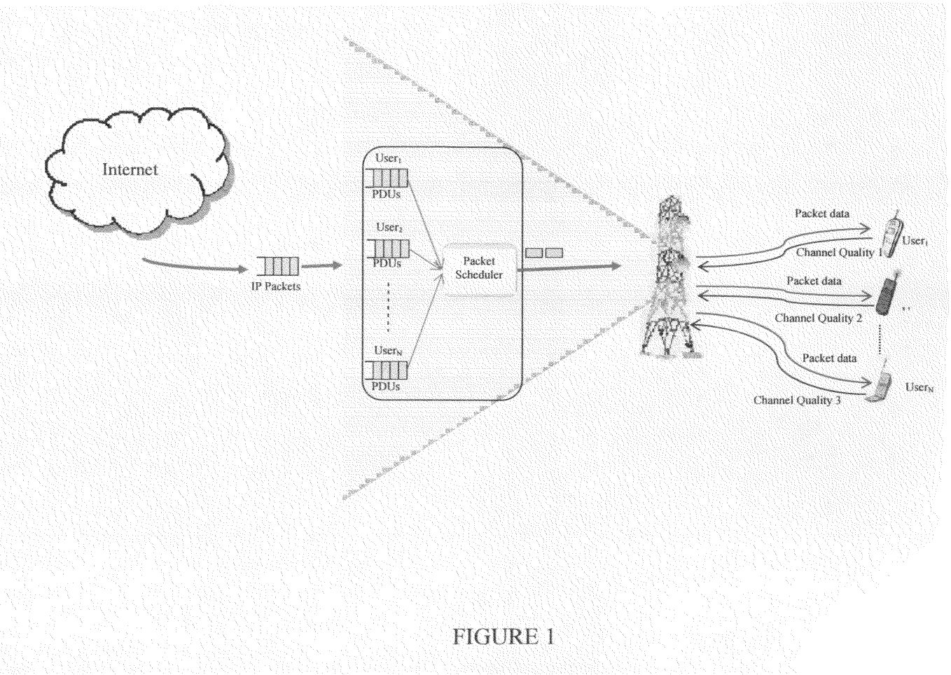

For a more complete understanding of the invention, the packet scheduler model and how it works over a downlink shared channel wireless network will first be described with reference to FIG. 1.

The packet scheduler may be implemented at the base station in a wireless network where the base station can serve n users simultaneously, n≧1, and users may belong to the same or different QoS classes, such as, for example, conversational, streaming, interactive, and background (as established by the 3rd Generation Partnership Project (3GPP) and 3rd Generation Partnership Project 2 (3GPP2)). Each QoS class is defined by one or more QoS metric. For example, traffic of the conversational class is defined by packet delay and packet loss QoS metrics. Examples of other QoS metrics may include channel quality, throughput, and delay jitter.

The packet scheduler selects for transmission one or a set of users in a frame of fixed or variable time duration. Also, and without loss of generality, it is assumed that each user has one connection request. Thus, the base station maintains one queue for every user as shown in FIG. 1. Upon call arrival, the wireless system receives traffic in the form of IP packets from higher layers, which are segmented into fixed size Protocol Data Units (PDUs). These PDUs are stored in the transmission queue of the corresponding user in a first-in first-out fashion. Subsequently, the PDUs are transmitted to the appropriate mobile user according to the adopted scheduling discipline.

The packet scheduler works as follows. Let the Transmission Time Interval (TTI) be the time between two consecutive transmissions. Every TTI, either the base station estimates instantaneous channel quality condition of the users that are within its coverage, or each user regularly informs the base station of this information through an uplink channel designed for this purpose. The base station then selects the appropriate users according to the adopted scheduling discipline and sends data to the selected users at the specified rates. Wireless cellular systems may include models that allow the base station to know the channel quality conditions of the users and estimate the data rates that they can support given this information. For example, the user in HSDPA is able to measure the current channel condition by measuring the power of the received signal from the base station (or Node B, as in UMTS and HSDPA), and then using a set of models described in [6] to determine the current supportable data rate (i.e., the rate that can be received from the Node B given the current channel condition). The base station can dynamically adjust the rates at which it sends data to users by using different modulation and coding techniques for different channel quality conditions. Therefore, users with good channel conditions will enjoy potentially higher supportable data rates by using higher modulation and coding rates, whereas users with poor channel conditions will experience lower data rates.

The UOC-PS utilizes realistic and practical economic models through the use of utility and opportunity cost functions. User i (1≦i≦n) satisfactions at time t as perceived by the service provider in a wireless network can be expressed by a utility function U(Xᵢ₁(t), Xᵢ₂(t), . . . , Xᵢₘ(t)), where n is the total number of users in the network, Xᵢ₁(t), Xᵢ₂(t), . . . , Xᵢₘ₋₁(t) are chosen quantitative measures of the user satisfactions in the network such as the average throughput, current data rate, average delay, etc., Xᵢₘ(t) is a fairness measure that represents how fair the scheduling algorithm is to the user, and m is the number of chosen quantitative measures. Assuming that the utility is additive, i.e., the aggregate utility of the

$$system = {\sum }_{i}^{n} U ( {X}_{i 1} ( t ) , {X}_{i 2} ( t ) , … , {X}_{im} ( t ) ) ,$$

then the scheduling algorithm can be formulated to be an optimization problem:

$$\{ V \} = Maximize {\sum }_{i}^{n} U ( {X}_{i 1} ( t ) , {X}_{i 2} ( t ) , … , {X}_{im} ( t ) )$$

$$S ubject to OC ( i , t ) \leq K$$

where OC(i,t) is the opportunity cost of serving user i at time t and K is a predefined constant value. That is, the scheduling algorithm will find the optimal set of users (i.e., V) such that if they are served, the system's aggregate utility will be maximized. Users are selected such that they satisfy the opportunity cost constraint and their transmission rates do not exceed the channel capacity. As used herein, the term “opportunity cost” refers to the cost of a good or service relative to the value of any other goods or services that a person must give up in order to produce or get that good or service [7]. The concept of opportunity cost arises because of the trade-off between throughput and fairness. If the scheduler tries to be fair, then the network's throughput will decrease and hence, the service provider's revenues might decrease if the users are charged on a per bit basis. This means that there is an opportunity cost of fairness.

For example, if m=2 and Xᵢ₁(t)=average user throughput, then according to the formulation above, we want to maximize Xᵢ₁(t) (i.e., average user throughput) along with some fairness measure (i.e., Xᵢ₂(t)). Therefore, the opportunity cost of fairness would be the trade-off between the value of the network throughput using this algorithm if the user with the best channel condition had been served, compared to the value when another user was served to satisfy the fairness measure. For example, let's say that the current data rate for user i, given his current channel condition, is 6 Mbps while the current data rate for user j, given the current channel condition, is 2 Mbps. Assume that after solving the optimization problem (i.e.,

$$Maximize {\sum }_{i}^{n} U ( {X}_{i 1} ( t ) , {X}_{i 2} ( t ) ) \text{)} ,$$

we find that the local maxima is achieved by serving user j, then the opportunity cost is 6−2=4 Mbps. Therefore, in order to be fair to users and also increase the system's throughput, then we would maximize U(Xᵢ₁(t), Xᵢ₂(t)) so that the opportunity cost in this case ≦4 Mbps.

As a further example, the opportunity cost of serving user i at time t (i.e., the opportunity cost of fairness) may be defined as follows:

OC(i,t)=(maxⱼRⱼ(t))−Rᵢ(t)

where Rᵢ(t) is equal to current supportable data rate for user i at time t which depends on the channel condition and maxⱼ Rⱼ(t) is equal to the maximum current data rate of all users at time t. That is, the opportunity cost is how much data rate the system would compromise if user i is selected for transmission given that there is a user j with a higher current data rate. As it can be seen, the opportunity cost is bounded to K and hence, it increases the obtained revenues of the service provider since the users with opportunity cost less than K are not served.

An example of a general utility function that expresses user satisfaction from service provider point of view is presented below along with definitions for QoS metrics and fairness measures that may be used in the general utility function for three types of traffic. These traffic types are: best-effort traffic where users have no specific QoS requirements other than achieving high average throughputs; traffic where users have data rate requirements; and traffic where users have packet delay requirements. The utility function and the QoS metrics are designed to simultaneously achieve four objectives which are efficiency, fairness, user satisfaction, and flexibility as mentioned above. The UOC-PS formulation may of course accommodate other utility functions, such as, for example, the Perfect Substitutes Utility Function, the Perfect Complement Utility Function (also called the Leontief Utility Function), and the Quasilinear Utility Function, as well as other QoS metrics, fairness measures, traffic types (e.g., traffic with packet loss requirements) and opportunity cost functions, and is not limited to those described below.

An example of a utility function suitable for use in the UOC-PS is the Cobb-Douglas utility function [7]. The Cobb-Douglas utility function was adapted for use in the UOC-PS. The Cobb-Douglas utility function is expressed as U(X₁, X₂)=X₁^{c}·X₂^{d} (assuming m=2 in the formulation of UOC-PS), where:

c≡Cobb-Douglas utility function constant, where c≧0. The value of this constant determines the weight on Xᵢ₁(t) in the Cobb-Douglas utility function.
d≡Cobb-Douglas utility function constant, where d≧0. The value of this constant determines the weight on Xᵢ₂(t) in the Cobb-Douglas utility function. We restrict the value of this constant to be an odd positive integer because our defined Xᵢ₂(t) in the adopted Cobb-Douglas utility function is a negative function as shown later and, therefore, d must be odd to preserve this.

Let X₁ be any performance metric that the service provider wants to optimize such as the average user throughput or average delay. Let X₂ be a fairness measure that increases as the user's or system's perception of fairness increases which results in an increase in U. Then we can express the preferences of user i at time t, 1≦i≦n, where n is the total number of users in the system, by:

U(Xᵢ₁(t),Xᵢ₂(t))=Xᵢ₁(t)^{c}·Xᵢ₂(t)^{d}

To maximize the network's overall utility, the highest possible values for Xᵢ₁(t) and Xᵢ₂(t) must be achieved for all users. However, it is not possible to achieve high values for both Xᵢ₁(t) and Xᵢ₂(t) for all users because of the trade-off between throughput and fairness as mentioned earlier. Therefore, one option is to find a user or set of users that if served, the system's utility will be maximized. Definitions of Xᵢ₁(t) and Xᵢ₂(t) in general, and for three traffic types discussed above, namely best-effort traffic, traffic with data rate requirements, and traffic with delay requirements, are provided below.

### General

The fairness measure for user i maybe defined as follows. Let: Sᵢ(t)=average throughput for user i up to time t, maxⱼ Sⱼ(t)=maximum average throughput achieved among all users up to time t. Given these two definitions, then the fairness measure for user i at time t, α₁(t) is defined as:

αᵢ(t)=Sᵢ(t)/(maxⱼSⱼ(t))

That is, the fairness measure for user i is the ratio between the average throughput of user i and the maximum throughput achieved among all users in the network. This measure is referred to as “relative fairness”. Therefore, if the user is receiving very low average throughput compared (or relative) to the user with the maximum average throughput, his relative fairness will be very low. As shown later, the objective of the utility function is to achieve high values of relative fairness to all users to increase the fairness of the network. Finally, the opportunity cost of serving user i at time t (i.e., the opportunity cost of fairness) is defined as follows:

OC(i,t)=(maxⱼRⱼ(t))−Rᵢ(t)

where Rᵢ(t) is equal to current data rate for user i at time t which depends on the channel condition, and maxⱼ Rⱼ(t) is equal to the maximum current data rate of all users at time t. That is, the opportunity cost is how much data rate the system would compromise if user i is selected for transmission given that there is a user j with a higher current data rate.

The terms Xᵢ₁(t) and Xᵢ₂(t) that are used in the Cobb-Douglas utility function are defined below. In addition to previous parameters, let

c≡Cobb-Douglas utility function constant, where c≧0. The value of this constant determines the weight on Xᵢ₁(t) in the Cobb-Douglas utility function.
d≡Cobb-Douglas utility function constant, where d≧0. The value of this constant determines the weight on Xᵢ₂(t) in the Cobb-Douglas utility function. We restrict the value of this constant to be an odd positive integer because our defined Xᵢ₂(t) in the adopted Cobb-Douglas utility function is a negative function as shown later and, therefore, d must be odd to preserve this.
n≡total number of users in the system.
Xᵢ₁(t)=Rᵢ(t), where Rᵢ(t)=the current data rate of user i at time t. The utility of user i being served increases as Rᵢ(t) increases. It should be noted that other performance metrics could be used instead of Rᵢ(t). However, we use the current data rate in the first component in the Cobb-Douglas utility function to increase the network capacity and hence, achieve the efficiency objective as explained in more detail below.
Xᵢ₂(t)=f(αᵢ(t), γᵢ(t))=1−γᵢ^{-ln(α}^{ᵢ}^{(t))}, γᵢ>1, is a fairness measure. It is a function of relative fairness as defined earlier in order to increase fairness in the network. The fairness measure is designed such that it increases as the user's relative fairness increases which increases the utility function (if the user is selected for transmission). This measure is used to ensure fairness among the users. The parameter γᵢ is used to control the shape of Xᵢ₂(t) and hence, the level of fairness in the network. γᵢ may be set to different values for different users to allow the service provider to maintain different levels of fairness for different users depending on the type of traffic they have, the amount of money they are expected to pay, their loyalty, etc. More details about how this function ensures fairness and the effect of γᵢ on the level of fairness that is provided by the network are given below.

Therefore, we can express the utility of user i at time t as follows:

U(Xᵢ₁(t),Xᵢ₂(t))=Xᵢ₁^{c}(t)·Xᵢ₂^{d}(t)=(Rᵢ(t))^{c}·(1−γᵢ^{-ln(α}^{ᵢ}^{(t))})^{d}

Assuming that the utility function is additive, then the aggregate utility of the system is:

$${\sum }_{i = 1}^{n} {( {R}_{i} ( t ) )}^{c} \cdot {( 1 - {{γ}_{i}}^{- ln ( {α}_{i } ( t ) )} )}^{d} \qquad ( 1 )$$

### Given the opportunity cost constraint, then at each scheduling decision, we find the user that would maximize the following objective function

$${\sum }_{i = 1}^{n} {( {R}_{i} ( t ) )}^{c} \cdot {( 1 - {γ}_{i}^{- ln ( {α}_{i} ( t ) )} )}^{d} \\ Subject to OC ( i , t ) \leq K ∀ i , where 1 \leq i \leq n \qquad ( 2 )$$

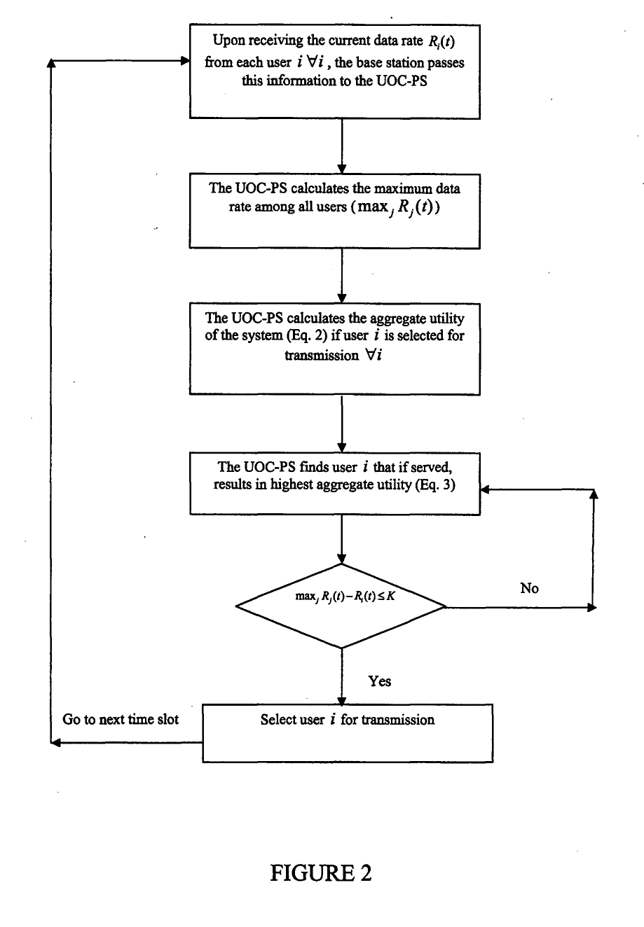

Note that the scheduling decision occurs every Time Transmission Interval (TTI) according to the assumed packet scheduler model. Thus, at each TTI, the current supportable data rate (Rᵢ(t)) of every user i is known and the average throughput Sᵢ(t) (and hence the relative fairness αᵢ(t)) may be calculated by using any throughput averaging method. Therefore, a solution of Equation 2 may found by computing the aggregate utility of the system if user i is scheduled (Equation 1) ∀i and then finding the user with the highest aggregate utility. In other words, a solution of Equation 2 may be found by choosing user i for transmission such that:

$${user}_{i} = {arg max}_{i} [ \begin{matrix}{( {R}_{i} ( t ) )}^{c} \cdot {( 1 - {γ}_{i}^{- ln ( {α}_{i} ( t ) )} )}^{d} + \\ {\sum }_{j = 1 , j \neq i}^{n} {( {R}_{j} ( t ) )}^{c} \cdot {( 1 - {γ}_{j}^{- ln ( {α}_{j} ( t ) )} )}^{d}\end{matrix} ] \qquad ( 3 )$$

where user i is selected for transmission and all other users j, j≠i, are not selected for transmission. (For simplicity, it is assumed that only one user is scheduled for transmission at each TTI. However, the UOC-PS scheme will work the same way if more than one user is scheduled.) If user i is selected for transmission then αᵢ(t) will increase and αᵢ(t) ∀j≠i will decrease as other users are not served. A detailed description of this process is illustrated in FIG. 2.

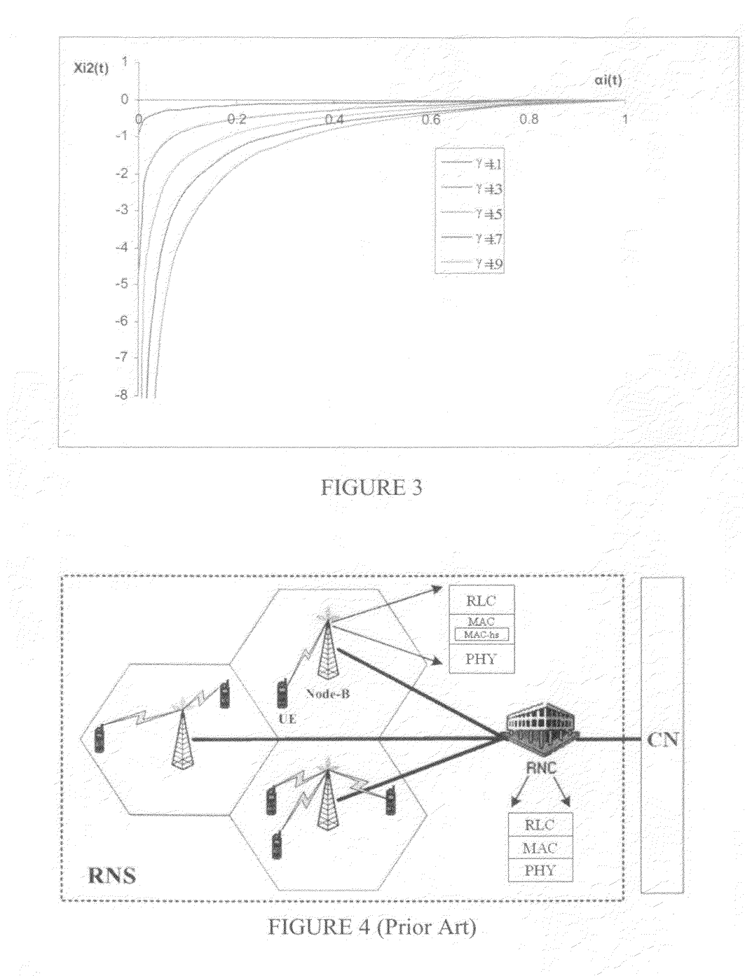

Two important factors affect the scheduling decision (i.e., the choice of user i). The first factor is the user's current supportable data rate (i.e., Rᵢ(t)), which depends on the channel condition. The user with higher current supportable data rate has a higher chance of maximizing the aggregate utility of the system. The second factor is the user's relative fairness (i.e., αᵢ(t)). In the utility function, Xᵢ₂(t) is a function of αᵢ(t) and γᵢ. Xᵢ₂(t) is designed such that it increases at a much faster rate if a user with a relatively low average throughput (e.g. αᵢ(t) close to 0) is served, rather than a user with a relatively high average throughput (e.g., αᵢ(t) close to 1). γᵢ determines the rate of decrease in Xᵢ₂(t). Larger values in γᵢ result in higher rates of decrease in Xᵢ₂(t) (especially as αᵢ(t) gets close to 0) which results in more fairness in the network as described next. FIG. 3 plots Xᵢ₂(t) for 0≦α≦1 for γᵢ fixed at 1.1, 1.3, 1.5, 1.7 and 1.9. As can be seen, Xᵢ₂(t) decreases at a much faster rate as the user's relative fairness decreases from 1 to 0 and it approaches −∞ as the user's relative fairness approaches 0. This ensures fairness among users since if a user with high average throughput is served, though his utility will increase, the overall utility will not be maximized due to the rapid decrease of the utilities of those with low average throughputs. Therefore, the scheduler will be forced to serve those with low average throughputs, since if served, their utility function will sharply increase which results in a maximization of the network's utility even though those users may not have the best channel conditions. As FIG. 3 shows, the larger the value of γᵢ, the higher rate of decrease in Xᵢ₂(t) (the rate of decrease in Xᵢ₂(t) increases as αᵢ(t) moves away from 1 towards 0) which allows the system to be more fair to users with low α values (i.e., low average throughputs compared to users with highest value). The service provider can choose different fixed values of γᵢ for different users depending on their traffic class, history, etc. Also, the values of γᵢ can be dynamically changed as needed by the service provider and according to the network statues. For example, the service provider may set γᵢ to a large value (i.e., more fairness) when the network is congested to ensure fairness among users, and set it to lower values (i.e., less fairness) when the network is under utilized. It will of course be appreciated that the above example may be adapted for multiple users.

### Best-Effort Traffic

For best-effort traffic each user cares only about maximizing his average throughput. The fairness measure for user i maybe defined as follows. Let: S̅ᵢ̅(̅t̅)̅=average throughput for user i up to time t, maxⱼ S̅ⱼ̅(̅t̅)̅=maximum average throughput achieved among all users up to time t. Given these two definitions, then the fairness measure for user i at time t, αᵢ(t) is defined as:

αᵢ(t)= S̅ᵢ̅(̅t̅)̅/(maxⱼ S̅ⱼ̅(̅t̅)̅)

That is, the fairness measure for user i is the ratio between the average throughput of user i and the maximum throughput achieved among all users in the network. This measure is referred to as “relative fairness”. Therefore, if the user is receiving very low average throughput compared (or relative) to the user with the maximum average throughput, his relative fairness will be very low. As shown later, the objective of the utility function is to achieve high values of relative fairness to all users to increase the fairness of the network. The terms Xᵢ₁(t) and Xᵢ₂(t) that are used in the Cobb-Douglas utility function for best-effort traffic are defined below.
Xᵢ₁(t)=Rᵢ(t), where Rᵢ(t)=the current data rate of user i at time t. The utility of user i being served increases as Rᵢ(t) increases. It should be noted that other performance metrics could be used instead of Rᵢ(t). However, we use the current data rate in the first component in the Cobb-Douglas utility function to increase the network capacity and hence, achieve the efficiency objective as explained in more detail below.
Xᵢ₂(t)=f(αᵢ(t), γᵢ(t))=1−γᵢ^{-ln(α}^{ᵢ}^{(t))}, γᵢ>1, is a fairness measure. It is a function of relative fairness as defined earlier in order to increase fairness in the network. The fairness measure is designed such that it increases as the user's relative fairness increases which increases the utility function (if the user is selected for transmission). This measure is used to ensure fairness among the users. The parameter γᵢ is used to control the shape of Xᵢ₂(t) and hence, the level of fairness in the network. γᵢ may be set to different values for different users to allow the network operator to maintain different levels of fairness for different users depending on the QoS class they belong to, the type of traffic they have, the amount of money they are expected to pay, their loyalty, etc. More details about how this function ensures fairness and the effect of γᵢ on the level of fairness that is provided by the network are given below.

Therefore, we can express the utility of user i at time t as follows:

U(Xᵢ₁(t),Xᵢ₂(t))=Xᵢ₁^{c}(t)·Xᵢ₂^{d}(t)=(Rᵢ(t))^{c}·(1−γᵢ^{-ln(α}^{₁}^{(t))})^{d}

Assuming that the utility function is additive, then the aggregate utility of the system is:

$${\sum }_{i = 1}^{n} {( {R}_{i} ( t ) )}^{c} \cdot {( 1 - {γ}_{i}^{- ln ( {α}_{i} ( t ) )} )}^{d} \qquad ( 1 )$$

### Given the opportunity cost constraint, then at each scheduling decision, UOC-PS will find the set of users that would maximize the following objective function if they are scheduled (selected) for transmission

$$\{ V \} = Maximize {\sum }_{i = 1}^{n} {( {R}_{i} ( t ) )}^{c} \cdot {( 1 - {γ}_{i}^{- ln ( {α}_{i} ( t ) )} )}^{d} \\ S ubject to OC ( i , t ) \leq K \qquad ( 4 )$$

Note that the scheduling decision occurs every Time Transmission Interval (TTI) according to the assumed packet scheduler model. Thus, at each TTI, the current supportable data rate (Rᵢ(t)) of every user i is known and the average throughput S̅ᵢ̅(̅t̅)̅ (and hence the relative fairness αᵢ(t)) may be calculated by using any throughput averaging method. Therefore, a solution to Equation 4 may found by computing the aggregate utility of the system if user i is scheduled ∀i and then finding the set of users (i.e., V) with the highest aggregate utility provided that they satisfy the constraint of Equation 4. In other words, a solution to Equation 4 may be found by choosing users for transmission such that:

$$\{ V \} = arg max [ \begin{matrix}{\sum }_{i ∈ V}^{ } {( {R}_{i} ( t ) )}^{c} \cdot {( 1 - {γ}_{i}^{- ln ( {α}_{i} ( t ) )} )}^{d} + \\ {\sum }_{j = 1 , j ∉ V}^{n} {( {R}_{j} ( t ) )}^{c} \cdot {( 1 - {γ}_{j}^{- ln ( {α}_{j} ( t ) )} )}^{d}\end{matrix} ] \\ Subject to OC ( i , t ) \leq K \qquad ( 5 )$$

where all users in set V are selected for transmission and all other users are not. If user i, iεV, is selected for transmission then αᵢ(t) will increase and αᵢ(t) ∀j∉V will decrease as user j is not served. A detailed description of this process is illustrated in FIG. 2.

Two important factors affect the scheduling decision (i.e., the choice of user i). The first factor is the user's current supportable data rate (i.e., Rᵢ(t)), which depends on the channel condition. The user with higher current supportable data rate has a higher chance of maximizing the aggregate utility of the system. The second factor is the user's relative fairness (i.e., Xᵢ₂(t)). In the utility function, Xᵢ₂(t) is a function of αᵢ(t) and γᵢ·Xᵢ₂(t) is designed such that it increases at a much faster rate if a user with a relatively low average throughput (e.g. αᵢ(t) close to 0) is served, rather than a user with a relatively high average throughput (e.g., αᵢ(t) close to 1). γᵢ determines the rate of decrease in Xᵢ₂(t). Larger values of γᵢ result in higher rates of decrease in Xᵢ₂(t) (especially as αᵢ(t) gets close to 0) which results in more fairness in the network as described next. FIG. 3 plots Xᵢ₂(t) for 0≦α≦1 for γᵢ fixed at 1.1, 1.3, 1.5, 1.7 and 1.9. As can be seen, Xᵢ₂(t) decreases at a much faster rate as the user's relative fairness decreases from 1 to 0 and it approaches −∞ as the user's relative fairness approaches 0. This ensures fairness among users since if a user with high average throughput is served, though his utility will increase, the overall utility will not be maximized due to the rapid decrease of the utilities of those with low average throughputs. Therefore, the scheduler will be forced to serve those with low average throughputs, since if served, their utility function will sharply increase which results in a maximization of the network's utility even though those users may not have the best channel conditions. As FIG. 3 shows, the larger the value of γᵢ, the higher rate of decrease in Xᵢ₂(t) (the rate of decrease in Xᵢ₂(t) increases as αᵢ(t) moves away from 1 towards 0) which allows the system to be more fair to users with low α values (i.e., low average throughputs compared to users with highest value). The network operator can choose different fixed values of γᵢ for different users depending on their traffic class, history, etc. Also, the values of γᵢ can be dynamically changed as needed by the network operator and according to the network statues. For example, the network operator may set γᵢ to a large value (i.e., more fairness) when the network is congested to ensure fairness among users, and set it to lower values (i.e., less fairness) when the network is under utilized.

Further, it can be mathematically shown [8] that if K is set to 0 then the UOC-PS converges to the Max CIR scheme. Also if

$$c = 0 , d = 1 , {γ}_{i} = {e}^{\frac{- ln ( 1 - ln {α}_{i} ( t ) )}{ln {α}_{i} ( t )}} ,$$

then the UOC-PS converges to the PF scheme, which gives the network operator even more flexibility to choose between different scheduling disciplines.

### Traffic with Data Rate Requirements

If network operator wants to maximize the system capacity and achieve certain bandwidth allocation to users (in case they have certain data rate requirements) then Xᵢ₁(t) and Xᵢ₂(t) in the Cobb-Douglas utility function may be defined as follows: Xᵢ₁(t)=Rᵢ(t), where Rᵢ(t)=the current data rate of user i at time t. This metric is used to maximize the system capacity.

$${X}_{i 2} ( t ) = f ( {α}_{i} ( t ) , {γ}_{i} ( t ) ) = 1 - {γ}_{i}^{- ln ( {α}_{i} ( t ) )} , {γ}_{i} > 1 , {α}_{i} ( t ) = \frac{\overline{{S}_{i} ( t )}}{{S}_{i}}$$

where S̅ᵢ̅(̅t̅)̅ is the average throughput of user i up to time t and Sᵢ is his requested data rate. Xᵢ₂(t) works as a fairness measure and its behavior is exactly the same as described in the case for best-effort traffic. This is because if the user is achieving a low average data rate compared to his requested one, then his utility will sharply decrease resulting in an overall decrease in the aggregate system utility. Therefore, Xᵢ₂(t) in this case works as performance monitor for the user in addition to being a fairness measure and hence, it aims at satisfying his requested data rate. In addition, γᵢ can be used not only to achieve different fairness levels but also different prioritizes to users, which allows the network operator to support different users with different data rate requirements.

It can be also shown that if K is set to 0 then the UOC-PS converges to the Max CIR scheme. Also if

$$c = 0 , d = 1 , {γ}_{i} = {e}^{\frac{- ln ( 1 - ln \overline{{S}_{i} ( t )} )}{ln ( \frac{\overline{{S}_{i} ( t )}}{{S}_{i}} )}} ,$$

then the UOC-PS converges to the PF scheme

### Traffic with Delay Requirements

If network operator wants to maximize the system capacity and maintain packet delay requirements for users then Xᵢ₁(t) and Xᵢ₂(t) in the Cobb-Douglas utility function may be defined as follows:

Xᵢ₁(t)=Rᵢ(t), where Rᵢ(t)=the current data rate of user i at time t. This metric is used to maximize the system capacity.

$${X}_{i 2} ( t ) = f ( {α}_{i} ( t ) , {γ}_{i} ( t ) ) = 1 - {γ}_{i}^{- ln ( {α}_{i} ( t ) )} , {γ}_{i} > 1 , {α}_{i} ( t ) = \frac{{D}_{i} - \overline{{D}_{i} ( t )}}{{D}_{i}}$$

where D̅ᵢ̅(̅t̅)̅ is the average packet delay of user i at time t and Dᵢ is the required packet delay of user i. In this case Xᵢ₂(t) and γᵢ work exactly as described above for best-effort traffic and traffic with data rate requirements except that in this case, they aim at satisfying the delay requirements of different users and achieve fairness based on the delay performance of users.

It can be also shown that if K is set to 0 then the UOC-PS converges to the Max CIR scheme.

It is useful to investigate the extent to which the UOC-PS algorithm satisfies the main objectives of efficiency, fairness, user satisfaction, and flexibility for which it was developed to simultaneously achieve.

Efficiency: The UOC-PS takes into account the instantaneous channel conditions of users (through their current supportable data rates) and gives more chance to users with good channel conditions to be selected for transmission. This provides efficiency.
Fairness: The UOC-PS takes into account not only the instantaneous channel condition of users, but also a fairness measure (e.g., relative fairness, such as, for example, users' average throughputs compared to the maximum average throughput) and it uses both in the scheduling decision.
User satisfaction: User satisfaction as perceived by the network operator is taken into account by using the instantaneous channel conditions of the users, fairness, and, in some embodiments, their QoS preferences. Exploiting information about the channel condition results in high user average throughputs, and this is what users want. In addition, the UOC-PS prevents users with bad channel conditions from getting low QoS performance by taking into account the fairness of the system to the users and, therefore, does not suffer from the problem of serving only those users with good channel conditions while ignoring the rest.
Flexibility: Introducing the concept of opportunity cost to the UOC-PS gives it a high degree of flexibility. This gives the network operator the flexibility to choose the degree of fairness and, therefore, control the throughput-fairness tradeoff. For example, in the UOC-PS, the opportunity cost function may be defined as OC(i,t)=(maxⱼ Rⱼ(t))−Rᵢ(t), subject to OC(i,t)≦K. That is, the opportunity cost may be defined as the loss of throughput if the user with the maximum data rate is not served. Therefore, the smaller the value K, the higher the opportunity cost, the higher the system throughput and the lower the degree of fairness (because only those whose current supportable data rates are close (depending on K) to the maximum one are chosen for transmission). The network operator may choose the appropriate values for K (for each Node B) to correspond to a certain degree of fairness in order to maximize its profits.

It is important to note that one or more of the channel quality condition, required data rate, required packet delay, and fairness may be used in the definitions of the utility function parameters (see, for example, as described above) since they are important performance metrics in any wireless system which may support multiple classes of traffic each having different QoS requirements. However, other QoS metrics may be included in the defined utility function such as but not limited to delay jitter, throughput, packet loss, and channel quality.

In addition, as noted above, the invention may be adapted to many wireless systems where centralized downlink packet scheduling is applicable. Examples of such wireless systems include but are not limited to HSDPA, 1×EV-DO Revisions 0, A and B, WiMAX and infrastructure-mode WiFi networks. Adapting the invention to HSDPA is described below in the working example. 1×EV-DO Revisions 0, A and B systems are very similar to HSDPA and hence, the working example applies to them except with very few differences that are not related to the scheduler (e.g., data rate supported, frame size, etc). In WiMAX, the time frame is divided between uplink and downlink transmission. The invention may be adapted to schedule users for the downlink transmission by deciding which users should use the downlink portion of the frame according to UOC-PS decisions which are based on the QoS classes of users, their QoS requirements and their channel quality conditions. In infrastructure-mode WiFi the invention may be used to schedule users in the contention-free period. For example, the invention may be used as HCCA scheduler in 802.11e.

The invention is further described by way of the following non-limiting example.

### Working Example

Performance of the UOC-PS was evaluated in a HSDPA network by means of dynamic discrete event simulation using Network Simulator (NS-2) [9] and its Enhanced UMTS Radio Access Network Extensions (EURANE) [10]. As mentioned above, HSDPA is a 3.5G wireless cellular system that was standardized as an extension to the existing 3G cellular system: UMTS. In HSDPA, a high-speed downlink data channel is shared by multiple users within the same cell to offer peak rates of 14.4 Mbps, 7 times larger than the data rate offered by UMTS. Packet scheduling plays a very important role in HSDPA since it determines how its high-speed downlink data channel is shared among users.

The architecture of the UMTS system and its extension will first be described. Then the simulation model and the channel model will be described.

### UMTS Architecture

The network architecture of UMTS as shown in FIG. 4 consists of three main elements [10]: (i) User Equipment (UE), (ii) UMTS Terrestrial Radio Access Network (UTRAN), and (iii) Core Network (CN). The UE is the device that provides the user with direct access to the network services. The UTRAN acts as a bridge between the UE and the CN, thus hiding all functionalities and overhead required to access the CN. The UTRAN is divided into individual Radio Network Systems (RNSs) where each RNS includes a Radio Network Controller (RNC) that controls one or more Node Bs (base stations), which in turn communicate with the User Equipment (UE). Scheduling and selection of transport format and retransmission are handled by the RNC. However, with the introduction of HSDPA some of the UMTS entities, in particular, Node B protocol layers, need to be upgraded to meet the design objectives. The three most important protocol layers that are implemented at Node B are the Radio Link Controller (RLC), the Medium Access Control (MAC), and the Physical Layer (PHY). In HSDPA a new MAC control sub-layer (MAC-hs) is added to the Node B protocol layers. The packet scheduler for HSDPA system is located at the MAC-hs, which is a major architectural change compared to UMTS where it was located at RNC. The main reason for this is to quickly obtain data information about the instantaneous channel conditions of the users in order to speed up the scheduling decisions based on this information.

### Simulation Model

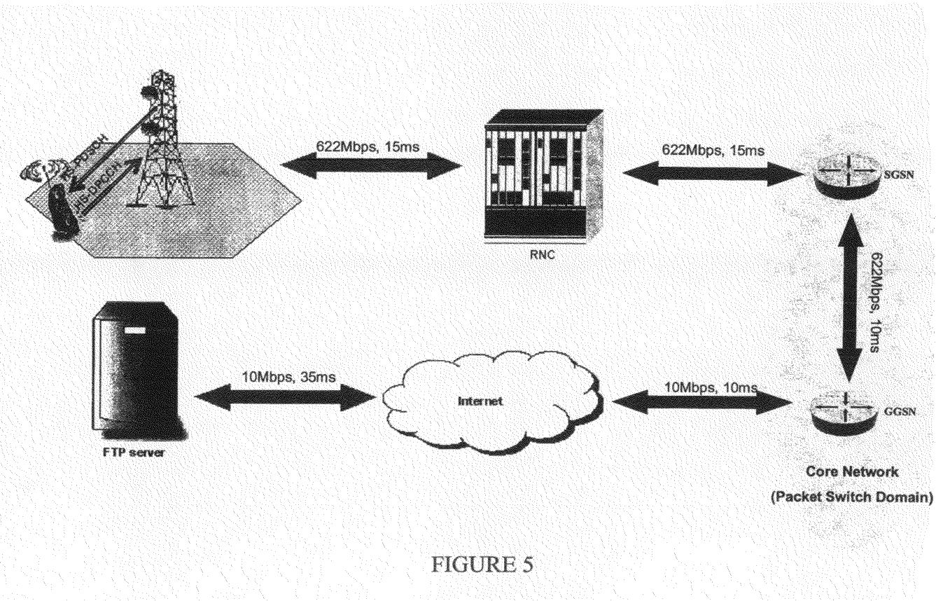

FIG. 5 shows the simulation model. A one-cell case was simulated and, for simplicity, handoff was not considered. The cell radius was 1 Km. The Node B was located at the center of the cell. Therefore, only one Node B was involved in allocating the radio resources. Users were connected to the Node B on the downlink by High Speed Physical Downlink Shared Channel (HS-PDSCH), which is the actual physical channel for HSDPA, and on the uplink by High Speed Physical Dedicated Control Channel (HS-PDCCH), which is used to send the users' current estimates of their channel conditions to the Node B. The Node B was connected to the Radio Network Controller (RNC) by a duplex link of 622 Mbps bandwidth and 15 ms delay. The RNC was connected to the Serving GPRS Support Node (SGSN) by a duplex link with 622 Mbps and 15 ms delay. The SGSN was connected to the Gateway GPRS Support Node (GGSN) by a duplex link of 622 Mbps bandwidth and 10 ms delay (the SGSN and GGSN are part of the Core Network (CN) and are used to support packet-switched services). The CN was connected to the Internet by a duplex link of 100 Mbps bandwidth and 10 ms delay. On the Internet, an FTP server was connected by a duplex link of 100 Mbps and 35 ms delay. All of these values can be found in [11].

For the simulation, each user sent a request for one FTP file and then the user's connection terminated after the download was complete. The size of each FTP file was 0.5 MB. Since FTP traffic (i.e., best-effort) was considered, the utility function for best-effort traffic (see above) was used.

At initialization, n users were uniformly distributed in the cell. Every user moved inside the cell with a constant speed of 3 km/h, which is the recommended value for Pedestrian A environment by the 3rd Generation Partnership Project (3GPP) [11]. The simulation time step was one time frame, which is 2 ms, and the simulation time was 100 s.

### Channel Model

The channel model describes how much the radio signal is attenuated on its way from the Node B to the user, and therefore it describes how the channel condition of the user changes with time depending on factors such as the environment and moving speed of the user. In the simulation, the propagation model consisted of five parts: distance loss, shadowing, multi-path fading, intra-cell interference, and inter-cell interference [11].

Each one of these parts was considered independent and was expressed in dB. The path loss was calculated as follows:

L(d)=137.4+10·β log₁₀(d)

where d is the distance from the UE to the Node B in kilometers, β is the path loss exponent and is equal to 3.52. Shadowing was modeled through a lognormal distribution with a mean value of 0 dB. The multi-path fading corresponded to 3GPP channel models for Pedestrian A environments. The intra-cell and inter-cell interference were assumed to be constants and were set equal to 30 and −70 dBm respectively. At the user side, the Signal-to-Noise Ratio (SNR) (the signal strength relative to background noise) was extracted from the received signal from the Node B to determine how strong the signal is according to the following formula [11]:

$$\begin{matrix}SNR = {P}_{τ x} - {L}_{Total} - 10 \cdot {log}_{10} ( {10}^{{{I}_{int ra} - {L}_{Total}}_{10}} + {10}^{{{I}_{int er}}_{10}} ) \\ = {P}_{τ x} - 10 \cdot {log}_{10} ( {10}^{{{I}_{int ra}}_{10}} + {10}^{{{I}_{int er} + {L}_{Total}}_{10}} )\end{matrix}$$

where Pₜₓ is the transmitted code power in dBm, L_{Total} is the sum of the path loss, shadowing, and multipath fading in dB, Iᵢₙₜᵣₐ and Iᵢₙₜₑᵣ are the intra and inter cell interference respectively in dBm.

The SNR was then mapped to a Channel Quality Index (CQI) that was used to determine the rate at which the user can obtain support from the Node B according to the following equation [3]:

$$CQI = \{ \begin{matrix}0 & SNR \leq - 16 \\ ⌊ \frac{SNR}{1.02} + 16.62 ⌋ & - 16 < SNR < 14 \\ 30 & 14 \leq SNR\end{matrix}$$

The HSDPA specification comes with tables that determine the data rates for each combination of CQI and channel codes used. These tables were used in the simulation and can be found at [3]. As it can be seen, the rates that the users can accept from the Node B vary in time depending on their location, speed, and the environment. Tables 1 and 2 summarize the UOC-PS parameter settings and the relevant simulation parameters.

### Simulation Results

The performance of the UOC-PS scheme was compared with the Maximum Carrier-to-Interference-Ratio (Max CIR) and Proportional Fairness (PF) schemes. Two tested environments were used: Pedestrian A (Ped A) [11] and Fixed Channel. Ped A environment is recommended by the 3GPP. Mobile users in Ped A environment move at a fixed speed of 3 km/hr. The Fixed Channel environment was created to evaluate the performance of the UOC-PS under different fixed channel conditions, which is not possible with the Ped A since the channel conditions of the users change with time according to the models specified by the 3GPP. The algorithms were compared in terms of the cell throughput, distribution of users' average throughputs, the user satisfaction in terms of providing a minimum average throughput guarantee, and percentage of packet loss due to buffer overflow and packet discarding.

TABLE 1
UOC-PS Parameter Settings

| | |
|---|---|
| c, d, γᵢ | 1, 1, 6¹ |

¹γᵢ = 6 for every user since only one type of traffic is considered here.

TABLE 2
Simulation Parameters

| Simulation time | 100 | s |
|---|---|---|
| Traffic type | FTP | |
| Node B transmission | 38 | dBm |
| power | | |
| Antenna gain | 17 | dBi |
| Node B buffer size | 30 | MB |
| Packet discard time | 6 | s |
| HS-DSCH codes | 10 | |
| Shadowing | Lognormal distribution | |
| Intra-cell interference | 30 | dBm |
| Inter-cell interference | −70 | dBm |

| | |
|---|---|
| Call arrival rate | Poisson with mean 1 s |

### Case 1: Pedestrian A (Ped A)

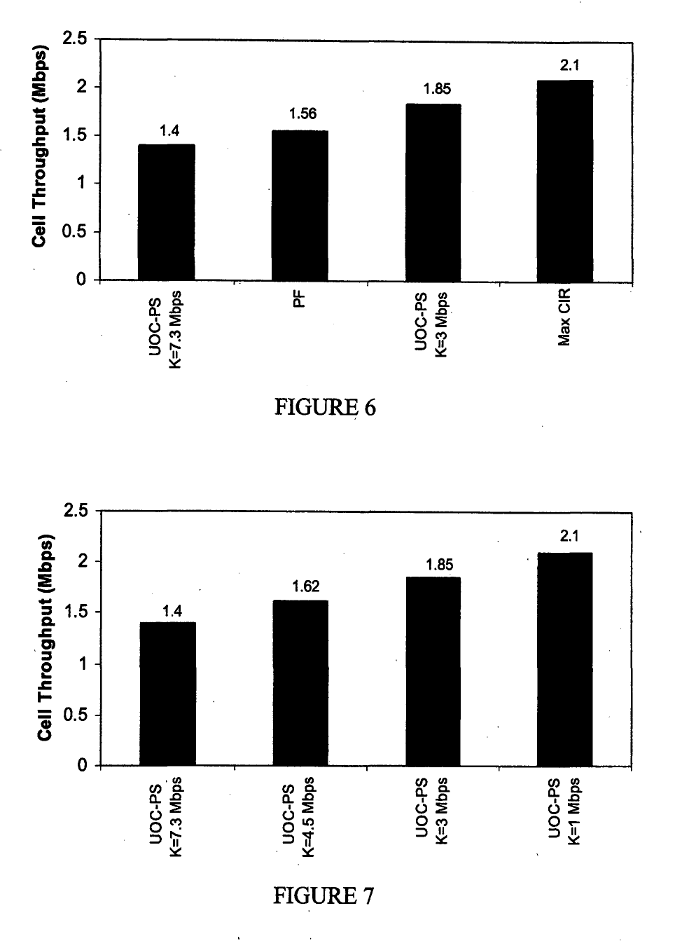

FIG. 6 compares the cell throughput of the evaluated algorithms for the Ped A environment with 25 users. The figure shows that the Max CIR algorithm achieved the highest cell throughput (2.1 Mbps). This was expected since the Max CIR algorithm only serves users at their best channel conditions at the expense of ignoring those with bad channel conditions. The cell throughput achieved by the UOC-PS with K=7.3 Mbps was slightly lower than the PF algorithm (1.4 Mbps compared to 1.56 Mbps). The reason for this is that the UOC-PS serves the users with low average throughputs more than the PF algorithm by giving them more time slots, so as to increase relative fairness and maximize the overall utility of the system. However, as K decreased to 3 Mbps (according to the above definition of the OC(i,t), the lower the value of K, the lower the fairness), the cell throughput increased from 1.4 Mbps to 1.85 Mbps. This is because when K=3 Mbps, only those with good channel conditions are served (i.e., their instantaneous channel conditions are good enough such that the opportunity cost of serving them does not exceed 3 Mbps). The effect of different values of K on the cell throughput is shown in FIG. 7. The figure confirms that the service provider can control the cell throughput by changing K, which is a unique feature of the UOC-PS.

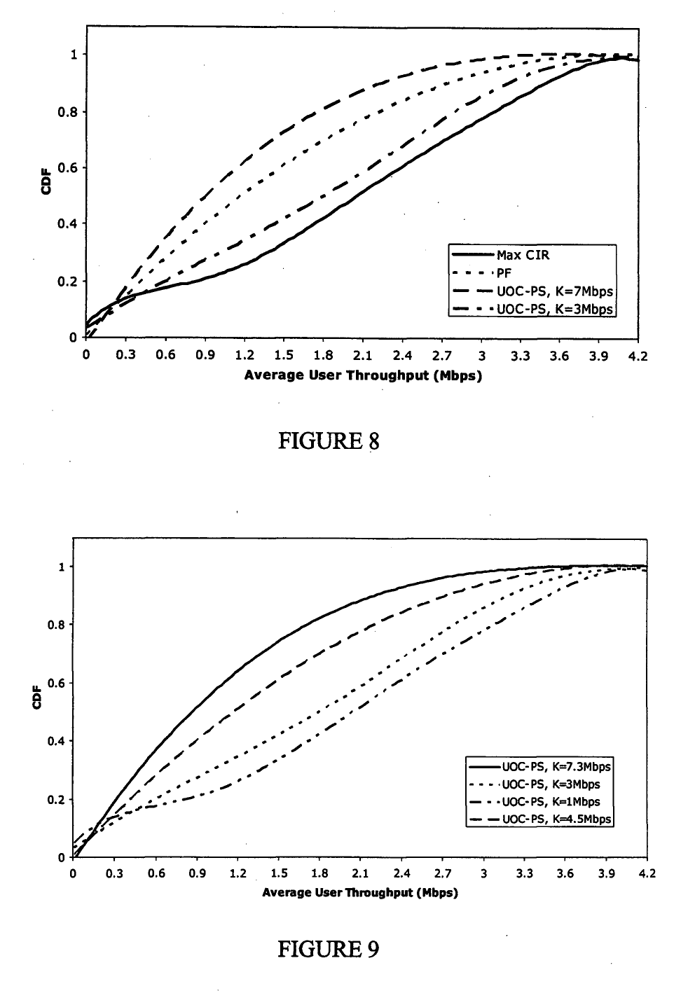

FIG. 8 depicts the Cumulative Distribution Function (CDF) of the users' average throughputs for the Ped A with 25 users. The steeper the CDF curve is, the fairer the algorithm because the users' average throughputs are distributed over a small interval (i.e., all users get relatively equal average throughputs). The UOC-PS has a steeper slope than the Max CIR and PF algorithms because of the effect of relative fairness which gives more time slots to users with low average throughputs to compensate for their bad channel conditions. FIG. 9 shows the CDF curves of the UOC-PS with different values of K. Clearly, the degree of fairness of the UOC-PS and hence the system throughput may be controlled by changing the value of K.

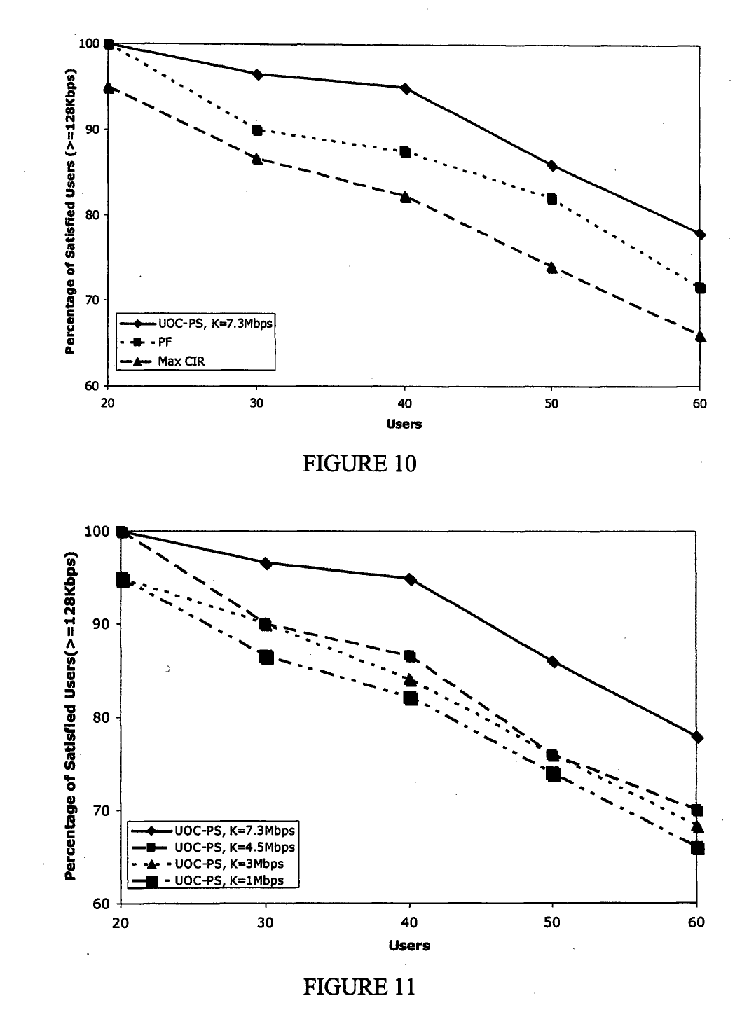

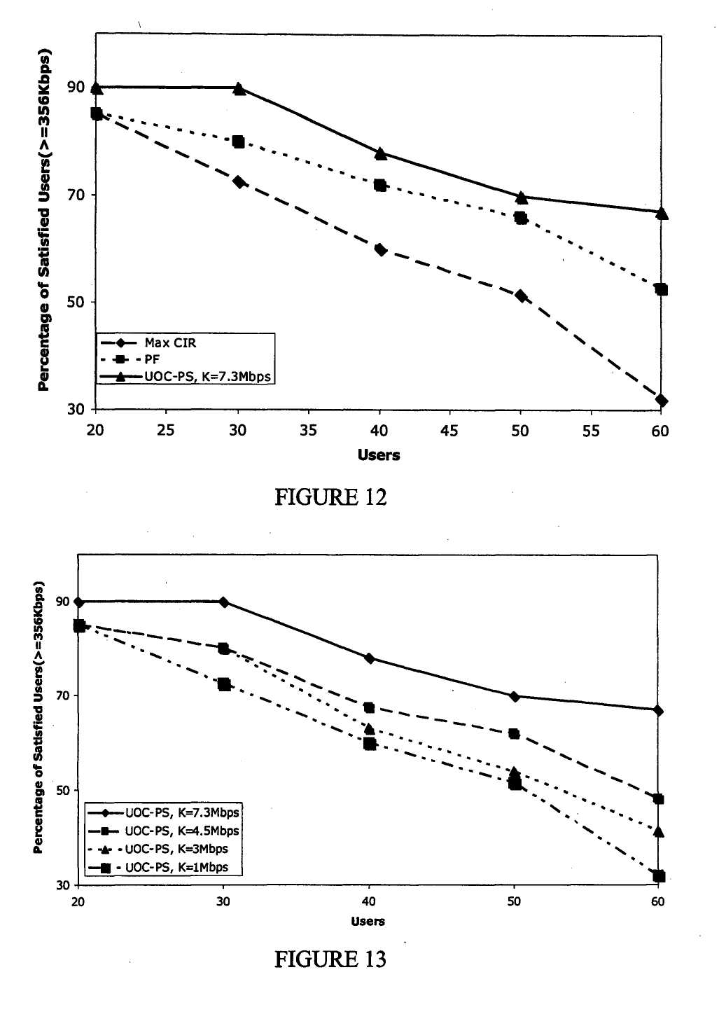

User satisfaction with a minimum average throughput of 128 Kbps (i.e., a user is satisfied if his average throughput is greater than or equal to 128 Kbps) is shown in FIG. 10. As can be seen, the UOC-PS algorithm outperformed the Max CIR and the PF schemes because it increased the chance of those users with low average throughputs of getting served, because of the effect of relative fairness. However, as shown in FIG. 11, as K decreased, fewer users were satisfied because with low K values only those with good channel conditions were selected for transmission at the expense of ignoring the rest of users. A similar behaviour was also observed with a minimum average throughput of 356 Kbps (FIGS. 12 and 13), except that the percentages of satisfied users were lower because it is more difficult to achieve a minimum throughput guarantee of 356 than 128 Kbps.

### Case 2: Fixed Channel

The scheduling algorithms were evaluated in this environment based on average user throughput and percentage of packet loss. Seven values were used for the SNR: −7, −4, −1, 2, 5, 8, and 11 dB (i.e., the channel conditions of the users were fixed at these values). For each SNR value, there were 10 users (a total of 70 users in the cell). Results for each group of 10 users based on their SNR were collected. For example, the average throughput was computed for users with SNR=−7 separately from users with SNR=−4, etc. This demonstrates how the scheduling algorithms serve users with different channel conditions.

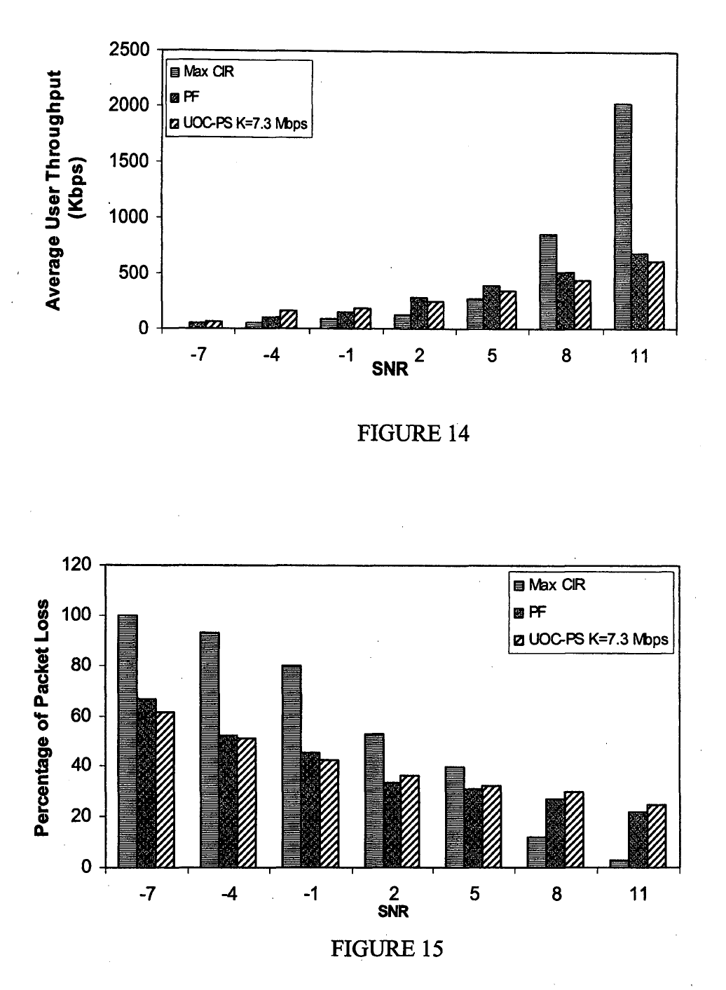

FIGS. 14 and 15 depict the users' average throughputs and the percentage of packet loss for users with different SNR values, respectively. Clearly, the UOC-PS achieved better performance in terms of user's average throughput and percentage of packet loss for users with low SNR values (e.g., −7, −4 and −1 dB). This is because of the effect of the fairness measure which ensures that the users who are having low average throughputs get more time slots to increase their relative fairness.

All cited publications are incorporated herein by reference in their entirety.

### EQUIVALENTS

Those skilled in the art may recognize or be able to ascertain variants to the embodiments described above. Such variants are within the scope of the invention and are covered by the appended claims.

### REFERENCES

[1] 3GPP TS 25.308, “High Speed Downlink Packet Access (HSDPA); Overall Description”, Release 5, March 2003.
[2] 3GPP2 CS0024, “CDMA2000 High Rate Packet Data Air Interface Specification”, Version 1.0, April 2004.
[3] S. Borst, “User-level Performance of Channel-aware Scheduling Algorithms in Wireless Data Networks,” Proc. of the IEEE INFOCOM, vol. 1, March 2003, pp. 321-331.
[4] A. Jalali, R. Padovani and R. Pankaj, “Data Throughput of CDMA-HDR a High Efficiency-high Date Rate Personal Communication Wireless System”, Proc. of the IEEE VTC, May 2000, pp. 1854-1858.
[5] M. Kazmi and N. Wiberg, “Scheduling Algorithms for HS-DSCH in a WCDMA Mixed Traffic Scenario”, Proc. of the IEEE PIMRC, Beijing, China, September 2003, pp. 1485-1489.
[6] 3GPP TS25.214, “Physical Layer Procedures”, Release 5, version 5.5.0, June 2003.
[7] H. Varian, “Intermediate Microeconomics: A Modern Approach”, 6th edition, W. W. Norton & Company, 2003.
[8] B. Al-Manthari, “Optimal Packet Scheduling In High Speed Downlink Packet Access”, M. Sc Thesis, Queen's University, September 2005.
[9] Network Simulator 2, Available: http://www.isi.edu/nsnam/ns/, November 2005.
[10] Enhanced UMTS Radio Access Network Extensions for NS2, Available: http://www.ti-wmc.nl/eurane/, November 2006.
[11] Deliverable D3. 2v2, “End-to-end Network Model for Enhanced UMTS”, Available: http://www.ti-wmc.nl/eurane/, November 2006.

1. A method for maximizing revenue of a wireless communications network provider, the network including a plurality of users, comprising:
determining packet scheduling for downlink transmission for each user according to a utility function and an opportunity cost function; and
scheduling transmission for each said user;
wherein the utility function considers the satisfactions and preferences of the users and the opportunity cost function considers the revenue preference of the service provider; and
wherein a result of the utility function and the opportunity cost function determines network fairness.

2. The method of claim 1, wherein the method is performed in a wireless network where centralized downlink packet scheduling is applicable.

3. The method of claim 2, wherein the wireless network is selected from HSDPA, I×EV-DO Revision 0, I×EV-DO Revision A, I×EV-DO Revision B, WiMAX, and infrastructure-mode WiFi networks.

4. The method of claim 1, wherein scheduling transmission comprises selecting for transmission a user that maximizes the utility function for the network and provides fairness to the users.

5. The method of claim 4, wherein network utility is the sum of users' utilities;
wherein users' utilities are based on one or more performance metrics and on the distribution of the performance metrics among users.

6. The method of claim 5, wherein the performance metric includes at least one of channel quality, throughput, delay, delay jitter, and packet loss.

7. The method of claim 1, wherein scheduling transmission comprises selecting for transmission a user that satisfies the opportunity cost function and provides fairness to the users.

8. The method of claim 1, wherein scheduling transmission comprises selecting for transmission a user that maximizes the utility function for the network subject to the opportunity cost function, and provides fairness to the users.

9. The method of claim 1, wherein fairness is determined by comparing a user's average throughput to the maximum average throughput of all users.

10. The method of claim 1, wherein network fairness to users is associated with an opportunity cost to the service provider.

11. The method of claim 1, wherein the opportunity cost of scheduling transmission for a user increases as the channel quality condition of the user deteriorates.

12. The method of claim 1, wherein fairness increases faster when a user with a low average throughput is selected for packet scheduling rather than a user with a high average throughput.

13. The method of claim 1, wherein service provider revenue is maximized by bounding the opportunity cost of scheduling transmission for a user and allowing the bound to control trade-off between network throughput and network fairness.

14. The method of claim 1, wherein the method is performed at each time transmission interval which is the time between two consecutive transmissions.

15. The method of claim 14, wherein the utility function is based on the Cobb-Douglas utility function.

16. The method of claim 1, wherein users have the same QoS requirements.

17. The method of claim 16, wherein the QoS requirements are related to a traffic type selected from best-effort traffic, traffic with data rate requirements, and traffic with delay requirements.

18. The method of claim 16, wherein the QoS requirements include one or more performance metric selected from channel quality, throughput, packet delay, delay jitter, and packet loss.

19. The method of claim 1, wherein users have different QoS requirements.

20. The method of claim 19, wherein the QoS requirements are related to two or more traffic types selected from best-effort traffic, traffic with data rate requirements, and traffic with delay requirements.

21. The method of claim 19, wherein the QoS requirements include one or more performance metric selected from channel quality, throughput, packet delay, delay jitter, and packet loss.

22. A packet scheduler adapted to implement the method of claim 1.

23. A wireless communications network comprising at least one packet scheduler of claim 22.

24. The wireless communications network of claim 23, wherein the packet scheduler is provided in a Medium Access Control (MAC) layer of the network.
